(19) United States
(12) Patent Application Publication
(10) Pub. No.: US 2002/0095488 A1
(43) Pub. Date: Jul. 18, 2002

(54) System and method for discovering, advertising, and finding networked services using dynamic directory

(76) Inventor: Leonard Primak, New York, NY (US)

Correspondence Address: FULBRIGHT & JAWORSKI, LLP, 666 FIFTH AVE, NEW YORK, NY, 10103-3198, US

(21) Appl. No.: 10/011,034

(22) Filed: Nov. 13, 2001

Related U.S. Application Data
(60) Provisional application No. 60/248,088, filed on Nov. 13, 2000.

(51) Int. Cl. G06F 15/173

(52) U.S. Cl. 709/223

(57) ABSTRACT

A method and system for advertising and updating network services on the network having a plurality of host machines connected thereto. The in-process dynamic directory associated with an application program residing in a host machine associates a network service to a network address specified in an advertising request received from the application program and transmits an update event message for the advertised network service via reliable multicast to a plurality of application programs residing in other host machines in the network.

### RELATED INFORMATION

This application is a continuation-in-part application of U.S. Provisional Application Serial No. 60/248,088 filed Nov. 13, 2000, which is incorporated by reference in its entirety.

### BACKGROUND OF THE INVENTION

The present invention generally relates to client-server communication between computers over a network, and more particularly to discovering, advertising and locating services over a network.

The recent explosion in client-server communication has resulted in the availability of different types of services over computer networks such as the Internet. The computers on a network are typically configured with a client process (“client”) that requests and obtains services from a server process (“server”) that normally resides on a different computer on the network. However, as the networked, distributed systems become increasingly more pervasive, the network administrators face taunting task of configuring every element in the network, such as clients, servers, peers and infrastructure.

Generally, the network services (“services”) providers use domain name registration service, such as domain name service (DNS), to register themselves on the Internet by recording an alias and a corresponding unique network address in a service directory or database. Thereafter, the provider can be located by its alias using a domain name resolution service that accesses the service directory.

There are several software tools that help a user identify and locate the thousands of different services that may be available on a given network. For example, the popular “web browsers”, such as Microsoft® Internet Explorer™ or Netscape Navigator™ are commonly used to “surf” the Internet. Web browsers provide their user access to Internet services according to the Transport Control Protocol/Internet Protocol (TCP/IP) suite of network communication protocols (“network protocols”).

If a user seeks a service and knows the alias of a service provider that offers a web site for access to that service, then the web browser can be used to look-up the network address of the server that provides the site by querying a domain name resolution service on the Internet. If the service provider had previously registered its name and network address, then the site's network or IP address is retrieved by the browser. The web site services can then be accessed through the browser by issuing a properly configured request such as an uniform resource locator (URL) that identifies the specific service protocol, the network address of the server, and any particular service options desired by the user such as the name of a file to be retrieved. In other words, the web browser plays the role of an application program that must not only know the location (network address) of the provider of services, but also be fluent in TCP/IP which is the transport and network layer protocol suite used to communicate over the Internet. The problem is that the application cannot browse for network services, unless the exact location and network communication protocol used by a provider of the network service are known by the application.

However, this manual configuration process is expensive, tedious and troublesome. Unless all of the elements in the network are configured, users cannot take full advantage of networked systems capabilities. To address this issue, various software solutions and protocols have been proposed for automatic discovery of network services, such as AppleTalk® Address Resolution Protocol (AARP), Name Binding Protocol and U.S. Pat. No. 6,167,449 which permit users to discover services only by type, e.g., discovering instances of printers and file servers, and service location protocol (SLP). The SLP is an Internet Engineering Task Force (IETF) standards-track protocol for discovering and using network resources without knowing the exact location of a service provider. However, these protocols and software solutions generally require a separate server that manages the service registrations of the various network service providers. That is, these various protocols and software solutions utilize a centralized mechanism to mange the service registrations.

Therefore, it is desirable to provide a method and system that does not rely on a central registration mechanism that requires at least one specific protocol enabled server or machine within each intranet or network. In other words, it is desirable to enable any application program to locate a service provider without having to “point” to a particular server or machine within the network to determine the exact location of a service provider.

### SUMMARY AND OBJECTS OF THE INVENTION

Therefore, it is an object of the present invention to provide a method and system for discovering, advertising and finding networked services that overcomes the shortcomings of the prior art.

In accordance with an embodiment of the present invention, a method and system provides a dynamic “in-process” naming process that does not utilized a centralized database and require installation/configuration to perform real-time search, advertisement and update of application or networked services.

In accordance with an embodiment of the present invention, a method and system for advertising and updating network services on the network having a plurality of host machines connected thereto is provided. The in-process dynamic directory associated with an application program residing in a host machine associates a network service to a network address specified in an advertising request received from the application program and transmits an update event message for the advertised network service via reliable multicast to a plurality of application programs residing in other host machines in the network.

Various other objects of the present invention will become readily apparent from the ensuing detailed description of the drawings.

### BRIEF DESCRIPTION OF THE DRAWINGS

The following detailed description, given by way of example, and not intended to limit the present invention solely thereto, will be best be understood in conjunction with the accompanying drawings:

FIG. 1 is a block diagram of a network incorporating the present invention; and

FIG. 2 is a block diagram of a machine incorporating the dynamic directory of the present invention.

### DETAILED DESCRIPTION OF THE EMBODIMENTS

The present invention is readily implemented using presently available communication apparatuses and electronic components. The invention finds ready application in virtually all communications system, including but not limited to the intranet, local area network (LAN), wide area network (WAN), Internet, private or public communication networks, wireless networks, satellite networks, cable networks or other online global broadcast networks.

With the networked, distributed systems becoming increasingly more pervasive, the network administrators and users face daunting task of advertising and locating networked services by name regardless of their location on the network. The network services or resources include, but not limited, to printers, web servers, fax machines, video cameras, file systems, back up devices (tape drives), databases, directories, mail servers, and calendars. In accordance with an embodiment of the present invention, the application program can advertise and locate network services without having the network or system administrator “point” to a SLP-enabled (other protocol specific) server or a particular service provider via an Internet protocol (IP) address or host name and TCP/IP port number. That is, the present invention replaces the cumbersome, inflexible and static configuration process (which can involve modifying a file on all connected machines to point to the appropriate service) with a dynamic distributed process that enables to network administrators to advertise and relocate services to different machines or ports on the fly.

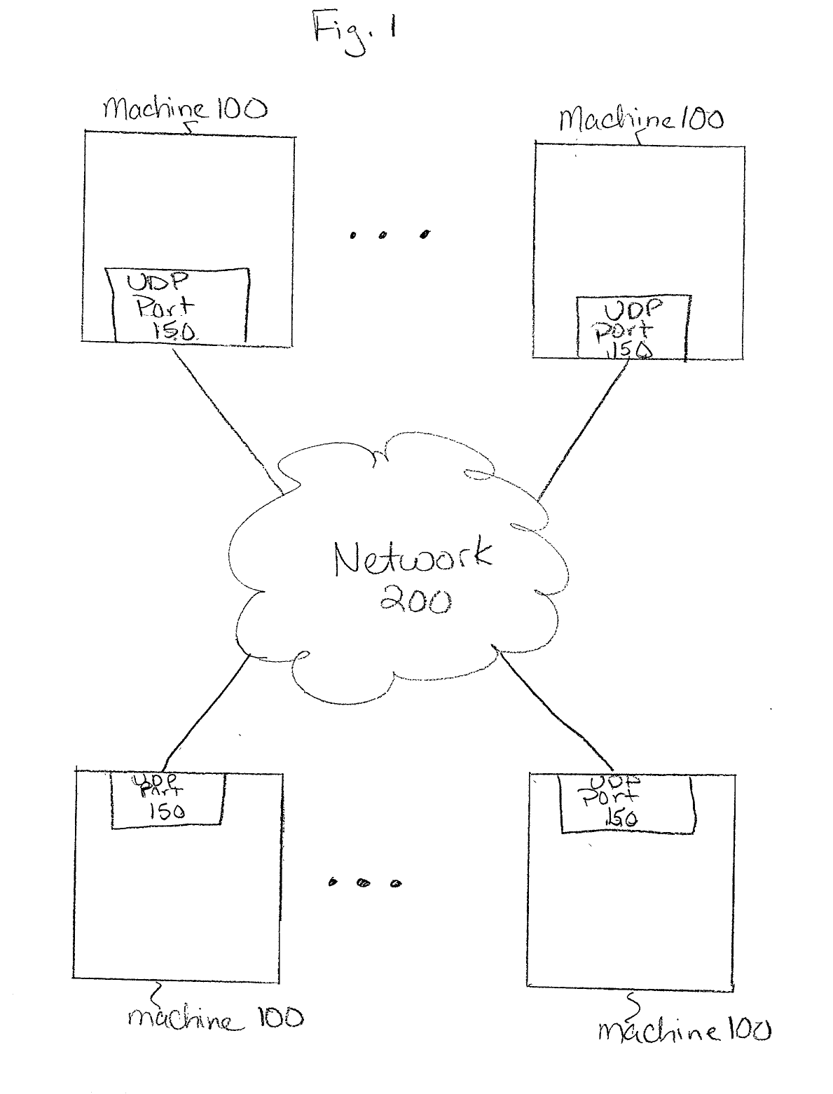

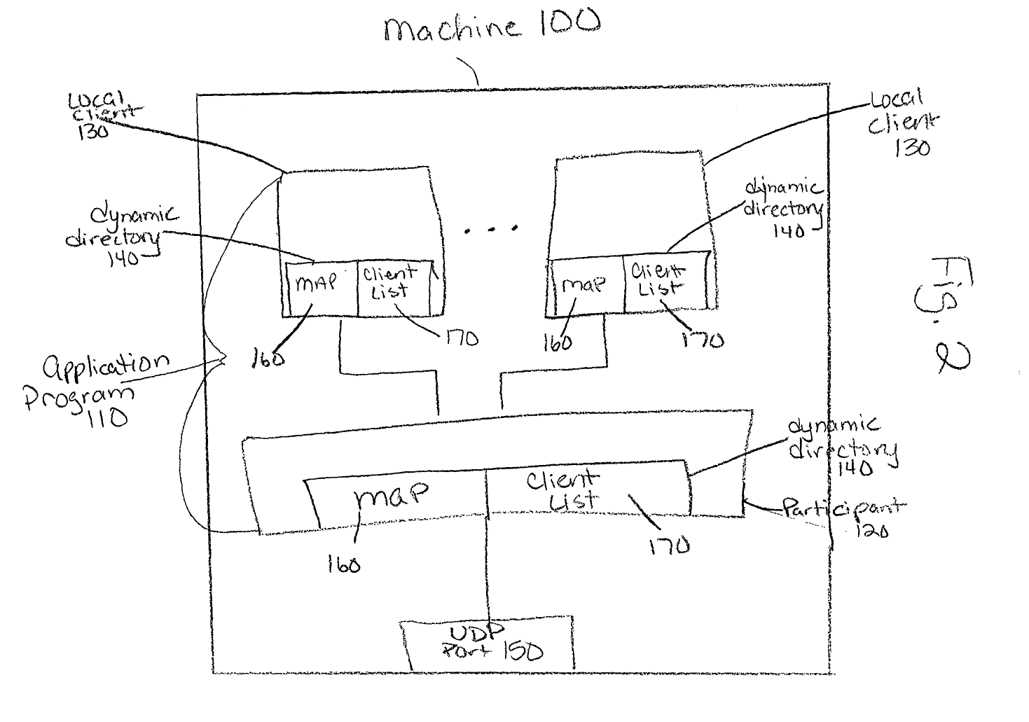

Turning now to FIGS. 1 and 2, in accordance with an embodiment of the present invention, each process or application program 110 (i.e., a participant 120 or a local client 130) operating or running in a machine or host machine 100 connected to a network 200 has a local copy of the dynamic directory 140, which maps the service names to a list of IP addresses/port numbers of service providers or servers (i.e., participants 120 and local clients 130) providing the requested services. Participants 120 and local clients 130 advertise, searches and utilizes network services on the network. That is, each participant or local client can either provide or receive services to/from another participant or local client residing in the same host machine 100 or in another host machine. However, since only one application program 110 in a given machine 100 can bind (i.e., listen and receive multicast messages) to the user datagram protocol (UDP) multicast port 150, only the application program 110 that binds to the UDP port 150 is designated as the participant 110 and all other application programs 110 running on the machine 100 are designated as the local clients 130.

In accordance with an aspect of the present invention, the dynamic directory 140 is a library that works “in-process” and communicates with other process or application programs 110 that are linked to the dynamic directory 140. The dynamic directory 140 maintains a map 160 mapping the service names to network addresses, such as IP addresses/port numbers, UDP port numbers or the like, of the service providers, and a multicast client list 170 containing a list of known participants 120. There are three basic operations associated with the dynamic directory 140: find, advertise and unadvertise. The find operation returns address/port number combination for a requested service or translates the requested service into IP address/port number pair. The application program 110 (i.e., a participant or local client) searches the dynamic directory 140 to find the desired service provider (i.e., a participant or local client) via host-local means, such as local host only sockets. The advertise operation associates a particular application service to a particular address in the dynamic directory 140 and the unadvertise operation removes such association in the dynamic directory 140.

An application program 110, such as the local client 130, searches or finds a network service by querying its local copy of the dynamic directory 140 for a service name. The dynamic directory 140 looks for an entry corresponding to the requested service name in its map 160. If the corresponding entry is found, then the dynamic directory 140 provides or returns address/port number combination for a requested service name. However, if the entry is not found in the dynamic directory, then the requested service was not advertised in the dynamic directory 140.

In accordance within an embodiment of the present invention, when a service provider (i.e., a participant 120) advertises or unadvertises a particular service, i.e., an update event, the dynamic directory 140 associated with the participant 120 is updated. The dynamic directory 140 of the participant 120 then sends the update event message to all participants 120 on its multicast client list 170 via the UDP port 150 using reliable multicast protocol, such as Spread, and to all local clients 130 via local host only sockets (not shown). In other words, advertise/unadvertise requests are processed locally by the participant 120 (or local client 130) using its local copy of the dynamic directory map 160, and then sends update event messages to all participants on the multicast client list 170. Local clients 130 connect to the participant 120 on its machine 100 to obtain the dynamic directory 140, preferably dynamic directory map 160 with the multicast client list 170, and any updates, such as the update events. To maintain an accurate map 160, the participants 120 periodically send a packet internet groper (or “ping”) message over the UDP port 150 to determine the existence of any unknown participants, i.e., participants 120 not currently on its multicast client list 170. If any unknown participants are discovered through the ping process by a participant 120, referred to herein as the originating participant, the originating participant exchanges the dynamic directory maps 160 with the unknown participants. The originating participant updates its dynamic directory map 160 with any new service entries discovered in the maps of the unknown participants and adds the unknown participants are added to its multicast client list 170. As noted herein, when its map is updated, the dynamic directory 140 of the originating participant sends the update event message to all participants 120 on its multicast client list 170 via reliable multicast and to all local clients 130 via local host only sockets.

The distributed approach of the present invention, wherein the map 160 is stored in each application rather in one central database or location, additionally offers fault tolerance and robustness. In other words, the dynamic directory 140 remains consistent and intact even when a participant 120 (i.e., an application program 110) terminates or dies, or when a machine 100 is disabled or removed from the network 200. When a participant 120 in a machine 100 terminates or dies, one of the local clients 130 in that same machine 100 takes over the role of the participant 120.

In accordance with an embodiment, the discovery operation, i.e., discovery of new participants 120 or service providers, of the present invention is described herein. Every predetermined time interval, such as every 30 seconds, each participant 120 sends a multicast “query ping” message. When another participant or receiving participant 120 receives such query ping message, it determines if the originating participant that transmitted the query ping message is in its multicast client list 170. If the originating participant is already on its multicast client list 170, the receiving participant 120 does nothing and simply ignores the query ping message. However, if it is determined that the originating participant is not on its multicast client list 170, the receiving participant sends a “refresh map from me” or “refresh map” message with a host system-specified transmission control protocol (TCP) port (or its UDP port number) accessible by the receiving participant to the originating participant. Upon receipt of the “refresh map” message, the originating participant connects to the TCP port specified in the “refresh map” message and obtains a copy of the receiving participant's map 160. As noted herein, the originating participant merges the receiving participant's map 160 into its existing map 160. That is, the originating participant updates its dynamic directory map 160 with any new service entries discovered in the maps of the receiving participant. After successfully merging the receiving participant's map into its own map, the originating participant sends an “AddMe” message to the receiving participant. Upon receipt of the “AddMe” message from the originating participant, the receiving participant adds the originating participant as a new client into it's multicast client list 170.

As part of the map merging process described herein, the originating participant sends an update event message (i.e., advertising or adding new service entries in the map 160) to all participants 120 on its multicast client list 170 via the associated UDP port 150 using reliable multicast protocol and to all local clients 130 via local host only sockets. The reliable multicast protocol can detect if the update event messages are not being properly acknowledged by a host machine 100 associated with a participant 120 receiving and acknowledging the update event message. For example, if a participant 120 (or an associated host machine 100) is inactive or does not respond to an update event message within a predetermined time, such as 15 seconds, the originating participant removes the “dead” or “nonresponding” participant from its multicast client list 170. This advantageously minimizes potential discontinuity in the update event stream, thereby insuring that various copies of the dynamic directory 140 distributed to each participant 120 in the network 200 are consistent and contain every advertised network services.

In accordance with an embodiment of the present invention, the classification operation by which an application program 110 is designated or classified as a participant 120 or a local client 130 is described herein. An application program 110 running on a host machine 100 attempts to bind to the multicast UDP port 150. If the application program 110 cannot bind to the multicast UDP port 150, then the application program 110 is designated as a local client 130 since there exists another application 110 running on the machine 100 that has been designated as the participant 120. The local client 130 sends a “ping participant” message. The participant 120 resident on the host machine 100 responds to the “ping participant” message with a local-only port number, to which the local client can connect to communicate with the participant 120. When the participant 120 resident on a host machine 130 terminates or dies for any reason, the first local client 130 which binds itself to the multicast UDP port 150 of the host machine 100 becomes the new participant 120 of the host machine 100. All other local clients 130 on the host machine 100 must now connect to this new participant 120.

While the present invention has been particularly described with respect to the illustrated embodiment, it will be appreciated that various alterations, modifications and adaptations may be made on the present disclosure, and are intended to be within the scope of the present invention. It is intended that the appended claims be interpreted as including the embodiment discussed above, those various alternatives, which have been described, and all equivalents thereto.

What is claimed:

1. A method of advertising and updating network services on the network having a plurality of host machines connected thereto, comprising the steps of:
receiving an advertising request having a network address from an application program residing in a host machine for a network service by an in-process dynamic directory in said host machine and associated with said application program;
associating said network service to said network address in said advertising request by said in-process dynamic directory; and
transmitting an update event message for said network service via reliable multicast to a plurality of application programs residing in other host machines in said network by said in-process dynamic directory.

2. The method of claim 1, wherein said network is a TCP/IP network and wherein said network address is an IP address/port number pair.

3. The method of claim 1, wherein said advertising request includes a service name of the advertised network service; wherein said in-process dynamic directory includes a map mapping service names to network addresses; and wherein the step of associating includes the step of entering a new service entry into said map for said service name.

4. The method of claim 3, wherein said dynamic directory includes a multicast client list comprising said plurality of application programs residing in other host machines; and further comprising the step of receiving an update event message for updating said map with a new service entry via reliable multicast from one or more application programs on said multicast client list.

5. The method of claim 4, further comprising the step of removing a non-responding application program from said multicast client list by said in-process dynamic directory if said non-responding application program does not respond to said update event message transmitted by said in-process dynamic directory within a predetermined time interval.

6. The method of claim 1, further comprising the step of transmitting said in-process dynamic directory via a local host only socket to one or more application programs residing in said host machine.

7. The method of claim 1, wherein the step of transmitting an update event message transmits said update event message via a local host only socket to one or more application programs residing in said host machine.

8. The method of claim 1, further comprising the step of
receiving a find request from said application program said in-process dynamic directory; and
translating said find request into a network address by said in-process dynamic directory.

9. The method of claim 8, wherein said find request includes a service name of the requested network service; wherein said in-process dynamic directory includes a map mapping service names to network addresses; and wherein the step of translating includes the step of searching said map for an entry corresponding to said service name by said in-process dynamic directory.

10. The method of claim 4, further comprising the step transmitting a ping message over said network by said application program to discover a new network service.

11. The method of claim 10, wherein the step of transmitting a ping message transmits said ping message every predetermined interval.

12. The method of claim 11, further comprising the steps of:
receiving said ping message from said application program by a receiving application program having an associated in-process dynamic directory and residing in another host machine;
determining by said receiving application program if said application program is in said multicast client list associated with said in-process dynamic directory of said receiving application program; and
transmitting a refresh map message to said application program by said receiving application program if it is determined that said application program is not in said multicast client list of said receiving application program; and
wherein said refresh map message includes a TCP port accessible by said receiving application program.

13. The method of claim 12, further comprising the steps of:
receiving said refresh map message from said receiving application program by said application program;
connecting to said TCP port to receive said map associated with said receiving application program; and
merging said map received from said receiving application program into said map associated with said application program.

14. The method of claim 13, further comprising the steps of:
transmitting an AddMe message to said receiving application program by said application program;
receiving said AddMe message by said receiving application program;
adding said application program to said multicast client list associated with said receiving program.

15. A system for advertising and updating network services on the network, comprising:
a plurality of host machines connected to said network;
an application program residing in a host machine; and
an in-process dynamic directory in said host machine and associated with said application program for:
receiving an advertising request having a network address from said application program;
associating said network service to said network address in said advertising request by said in-process dynamic directory; and
transmitting an update event message for said network service via reliable multicast to a plurality of application programs residing in other host machines in said network.

16. The system of claim 15, wherein said network is a TCP/IP network and wherein said network address is an IP address/port number pair.

17. The system of claim 15, wherein said advertising request includes a service name of the advertised network service; wherein said in-process dynamic directory comprises a map mapping service names to network addresses and is operable to enter a new service entry into said map for said service name.

18. The system of claim 17, wherein said dynamic directory comprises a multicast client list comprising said plurality of application programs residing in other host machines and is operable to receive an update event message for updating said map with a new service entry via reliable multicast from one or more application programs on said multicast client list.

19. The system of claim 18, wherein said in-process dynamic directory is operable to remove a non-responding application program from said multicast client list if said non-responding application program does not respond to said update event message transmitted by said in-process dynamic directory within a predetermined time interval.

20. The system of claim 15, wherein said application program is operable to transmit said in-process dynamic directory via a local host only socket to one or more application programs residing in said host machine.

21. The system of claim 15, wherein said application program is operable to transmit said update event message via a local host only socket to one or more application programs residing in said host machine.

22. The system of claim 15, wherein said in-process dynamic directory is operable to receive a find request from said application program and translate said find request into a network address.

23. The system of claim 22, wherein said find request includes a service name of the requested network service; wherein said in-process dynamic directory comprises a map mapping service names to network addresses and is operable to search said map for an entry corresponding to said service name.

24. The system of claim 18, wherein said application program is operable to transmit a ping message over said network to discover a new network service.

25. The system of claim 24, wherein said application program is operable to transmit said ping message every predetermined interval.

26. The system of claim 25, further comprising a receiving application program, having an associated in-process dynamic directory and residing in another host machine, for:
receiving said ping message from said application program;
determining if said application program is in said multicast client list associated with said in-process dynamic directory of said receiving application program; and
transmitting a refresh map message to said application program if it is determined that said application program is not in said multicast client list of said receiving application program; and
wherein said refresh map message includes a TCP port accessible by said receiving application program.

27. The system of claim 26, wherein said application program is operable to:
receive said refresh map message from said receiving application program;
receive said map associated with said receiving application program via said TCP port; and
merge said map received from said receiving application program into said map associated with said application program.

28. The system of claim 27, wherein said application is operable to transmit an AddMe message to said receiving application; and wherein said receiving application program is operable to receive said AddMe message by said receiving application program and add said application program to said multicast client list associated with said receiving program.
